(19) United States
(12) Patent Application Publication
(10) Pub. No.: US 2008/0087684 A1
(43) Pub. Date: Apr. 17, 2008

(54) Shield for self-defense provided with a spray device

(76) Inventor: Masaya Koshimoto, Takaoka - shi (JP)

Correspondence Address: FLYNN THIEL BOUTELL & TANIS, P.C., 2026 RAMBLING ROAD, KALAMAZOO, MI, 49008-1631, US

(21) Appl. No.: 11/544,892

(22) Filed: Oct. 6, 2006

(51) Int. Cl. B67D 5/06

(52) U.S. Cl. 222/192; 239/288; 89/36.01; 89/36.07; 446/473; 222/78

(57) ABSTRACT

There is provided a shield for self-defense provided with a spray device capable of securing safety by always and reliably supporting the shield so as to eject a spray with a simple operation while using the a hand gripping the shield. The shield for self-defense provided with a spray device comprises a shield body, a longitudinal handle serving as a spray device standing upright from a back face of the shield body so as to be gripped while laying an elbow on the back face of the shield body, an arm holder for fixing the elbow thereon, wherein the longitudinal handle and the arm holder are protruded from and disposed at the left and right sides on the central portion between the upper and lower portions of the shield body, and wherein the longitudinal handle is shaped in a cylindrical form so as to house a spray can therein, and the spray can is covered with a cap provided at the upper end of the cylindrical form, and when the spray can is pushed by the cap, a spray for threat and defense can be ejected toward a front face of the shield body.

### FIELD OF THE INVENTION

The invention relates to a shield for self-defense provided with a spray device capable of ejecting a spray having a fierce stimulant and hypnotic effect so that a mobile police, self-defense forces, security agents and so forth can quell ad repulse mobs and ruffians.

### BACKGROUND OF THE INVENTION

In a mobilization site of a mobile police, and so forth, a shield has been be used for protecting a body from sling, blow by a club, shoot-up, and so forth. However, a full sufficient effect can not be expected for such a defense, so that an applicant of this application proposed a shield for self-defense provided with a spray device as disclosed in Japanese Patent No. 3,606,572 so as to apply a striking power and a repression force to such a shield.

The shield for self-defense provided with a spray device described above is made of a high-strength material such as a polycarbonate, and so forth, as shown in FIG. 6, and it comprises a shield body 80, a pair of support members 82, 82 protruding from the back of the shield body 80, and a handle 84 extended between the pair of support members 82, 82 each provided with a spray device. The spray device is described more in detail with reference to a first embodiment of the invention. The pair of support members 82, 82 each are made of a housing cylinder 10 in which a spray can 9 can be filled and an spray hole 17 is provided at a connection portion between the housing cylinder 10 and the shield body 1 for receiving a nozzle 21 (a nozzle 21 of the spray can 9 is biased by an internal spring, not shown, in a direction to be sprayed from the spray can 9), wherein if the spray can 9 is pushed against resiliency of a coil spring 19, the nozzle 21 is moved inward the spray can 9, so that a content of the spray can 9 is ejected, thereby effecting spray from the spraying hole 17 toward the front of the shield body 1. Since a cap 23 made of a flexible rubber material is mounted on a cylindrical tip end of the housing cylinder 10 for sealing the spray can 9, so that the spray can 9 is pushed above the cap 23.

According to the conventional shield for self-defense provided with a spray device, the spray can 9 is housed inside the support members 82, 82 which are protruded from the back face of the shield body 1, and when the spray can 9 is pushed by the cap, a spray can be ejected. At this point in time, it needs a pushing operation while thrusting out the thumb of a hand gripping the handle 84 extended between the support members 82, 82 so that the handle is poorly gripped, leading to a danger not to sufficiently and reliably support the shield.

### SUMMARY OF THE INVENTION

In view of the circumstances described above, it is an object of the invention to provide a shield for self-defense provided with a spray device capable of securing safety by always and reliably supporting the shield so as to eject a spray with a simple operation while using the a hand gripping the shield.

To achieve the above object, it is a first aspect of the invention to provide a shield for self-defense provided with a spray device comprising a shield body, a longitudinal handle serving as a spray device standing upright from a back face of the shield body so as to be gripped while laying an elbow on the back face of the shield body, an arm holder for fixing the elbow thereon, wherein the longitudinal handle and the arm holder are protruded from and disposed at the left and right sides on the central portion between the upper and lower portions of the shield body, and wherein the longitudinal handle is shaped in a cylindrical form so as to house a spray can therein, and the spray can is covered with a cap provided at the upper end of the cylindrical form, and when the spray can is pushed by the cap, a spray for threat and defense can be ejected toward a front face of the shield body.

With the arrangement of the shield for self-defense provided with a spray device of the first aspect of the invention, since the portion to be gripped by a hand is a longitudinal handle protruded from the back face of the shield body, the shield body can be supported not only directly by the hand but also by the arm holder, and hence while the shield body is supported by two portions, the cap be pushed by a thumb naturally with ease, thereby ejecting a spray.

It is a second aspect of the invention to provide a shield for self-defense provided with a spray device comprising a shield body, an extension handle serving as a spray device laid over and positioned away from the back face of the shield body so as to be gripped while laying an elbow on the back face of the shield body, an arm holder for fixing the elbow thereon, a wrist pad for laying a wrist thereon, a pair of supporting members each shaped in a cylindrical form so as to house a spray can therein for supporting the extension handle extended therebetween, and a movable lever provided over the extension handle to be gripped by a thumb to push the cap, wherein the arm holder, the extension handle, and the wrist pad are disposed at the left and right sides of the shield body, and wherein the spray can is covered with a cap provided at the upper end of the cylindrical form, and when the spray can is pushed by the cap, a spray for threat and defense can be ejected toward a front face of the shield body.

With the arrangement of the shield for self-defense provided with a spray device of the second aspect of the invention, the movable lever is pushed downward by a thumb of a hand which grips the extension handle so as to press the cap of the supporting member, thereby operating the spray device with ease, so that the shield can be reliably supported by the arm holder and the wrist pad in this case.

It is a third aspect of the invention to provide a shield for self-defense provided with a spray device comprising a shield body, a pair of upper and lower supporting members each serving as a spray device and protruded from the back face of the shield body, an extension handle extended between the supporting members, a trigger connected to a connection member for connecting the extension handle and the upper supporting member by a pin, wherein the supporting members are shaped in a cylindrical form so as to house a spray can therein, and the spray can is covered with a cap provided at the upper end of the cylindrical form, the cap being pushed by a tip end of the trigger, and when the spray can is pushed by the cap, a spray for threat and defense can be ejected toward a front face of the shield body.

With the arrangement of the shield for self-defense provided with a spray device of the third aspect of the invention, the shield is supported by gripping the extension handle, and a spray is ejected by a very simple operation of triggering the trigger.

It is a fourth aspect of the invention to provide a shield for self-defense provided with a spray device comprising a shield body, a main handle (gripped vertically by a hand) protruded from the back face of the shield body at a central portion thereof, and an auxiliary handle protruded from the back face of the shield body at either a right corner or a left corner of the upper portion thereof, wherein both the main handle and the auxiliary handle or either the main handle or the auxiliary handle serves as a spray device, and the spray device has a housing cylinder in which a spray can is filled, and the housing cylinder is covered with a cap provided at the upper end thereof, and when the cap is pushed by a thumb, a spray for threat and defense can be ejected toward a front face of the shield body.

With the arrangement of the shield for self-defense provided with a spray device of the fourth aspect of the invention, since the main handle provided at the center of the shield body and the auxiliary handle provided at one upper corner of the shield body displaced from the center of the shield body can be gripped by both hands, very strong stability can be obtained, so that the cap can be pushed by one hand.

As mentioned above, according to the shield for self-defense provided with a spray device of the invention, since a spray can be ejected with a simple operation while using the hand gripping the shield, the shield can be always reliably supported, and there is an excellent effect that a variety of sprays comprising such as hypnotic gas, red pepper and so forth can be reliably ejected, thereby displaying a tactical mobility in full while coping with mobs with safety to enhance repression effect.

### BRIEF DESCRIPTION OF THE DRAWINGS

FIG. 1 is a perspective view of a shield for self-defense provided with a spray device as shown from a back face thereof according to a first embodiment of the invention;

FIG. 2 is a sectional view of a main part of the shield for self-defense provided with a spray device taken along A-A in FIG. 1;

FIG. 3 is a perspective view of a shield for self-defense provided with a spray device as shown from a back face thereof according to a second embodiment of the invention;

FIG. 4 is a sectional view of a main part of a shield for self-defense provided with a spray device as shown from a side face thereof according to a third embodiment of the invention;

FIG. 5 is a perspective view of a shield for self-defense provided with a spray device as shown from a back face thereof according to a fourth embodiment of the invention; and

FIG. 6 is a perspective view of a prior art.

### PREFERRED EMBODIMENT OF THE INVENTION

Embodiments of the invention are now described with reference to the accompanying drawings.

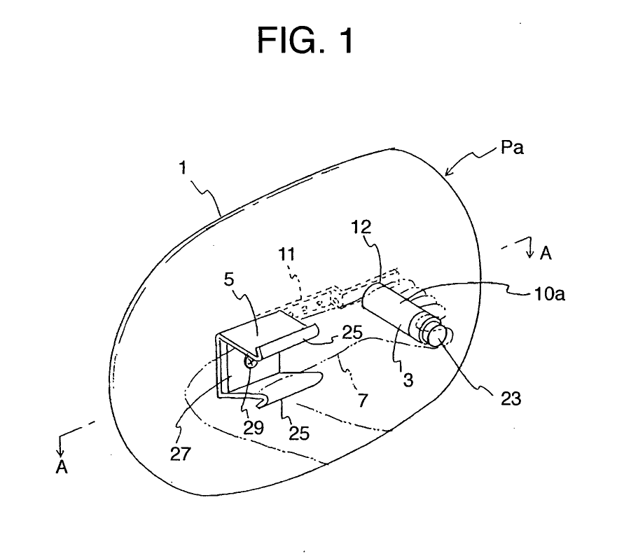

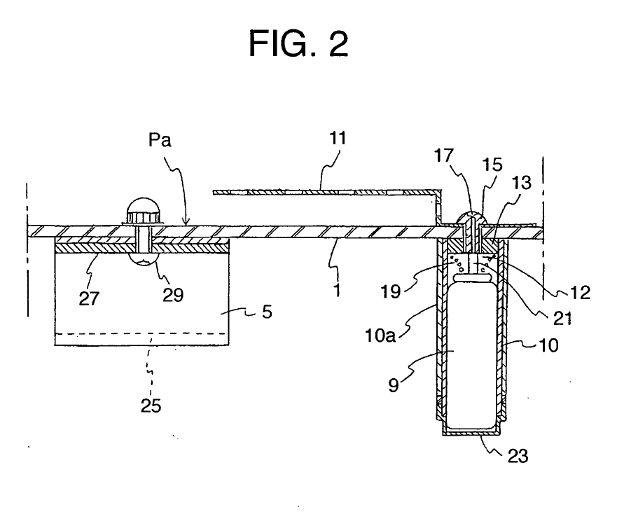

FIG. 1 and FIG. 2 show a shield for self-defense Pa provided with a spray device according to the first aspect of the invention. A shield body 1 has a shape close to an elliptical shape which is long sideways and is formed in a curved shape projected toward the front ace of the shield body 1 at the elevational center thereof. A longitudinal handle 3 is protruded from a back face of the shield body 1 at right side, and an arm holder 5 in which an arm 7 for gripping the longitudinal handle 3 is laid for fixing the elbow is protruded from the back face of the shield body 1. The longitudinal handle 3 is made up of a housing cylinder 10 of a spray can 9, thereby forming a spray device 12. A hook piece 11 made of a metal strip-shaped sheet to be hooked on a wall or the waist is provided on the front face of the shield body 1. The housing cylinder 10 is covered with an elastic member 10a.

The longitudinal handle 3 is formed of the housing cylinder 10 of the spray can 9, and an attachment base 13 to be fitted on the base end of the housing cylinder 10 is fixed to the shield body 1 by a screw 15 and the housing cylinder 10 is fitted to the housing cylinder 10, and the housing cylinder 10 is fitted on the attachment base 13, thereby adhering them. A spray hole 17 is formed on the center of the screw 15. A trumpet-shaped coil spring 19 is housed in the housing cylinder 10 so as to be seated on the attachment base 13. If the spray can 9 is inserted into the housing cylinder 10, a nozzle 21 provided on the tip end of the spray can 9 passes through the center of the coil spring 19 to touch the spray hole 17. In this state, a cap 23 is mounted on the housing cylinder 10, thereby completing the filling of the spray can 9 to be rendered in a state to be readily used.

Since the cap 23 is formed of a flexible rubber, if the spray can 9 is pushed by pushing the cap 23, the nozzle 21 is pushed toward the opening edge of the spray hole 17 which is opened in the screw 15, so that the nozzle 21 is pulled toward the housing cylinder 10, thereby ejecting a spry or a content in the housing cylinder 10 forward through the spray hole 17.

The hook piece 11 is formed by bending the metal strip-shaped sheet in steps and it is hooked by the screw 15 at its base end, so that it is held at its tip end portion in parallel with the shield body 1 in a spaced relation relative to the shield body 1 while leaving a space therebetween.

The arm holder 5 has a channel-shaped in cross section so as to hold the arm 7, and is formed narrower sequentially toward the opening thereof, and has warped portions 25, 25 at both edges of the opening. Since a cushion 27 is placed on the bottom of the arm holder 5, and the bottom portion of the arm holder 5 is securely fixed to the shield body 1 by a screw 29, an operator can hold the shield Pa at the ready with safety while carrying the longitudinal handle 3 by the arm 7 which is held by the arm holder 5. When threatening an opponent by ejecting a spray, a thumb gripping the longitudinal handle 3 is placed on the cap 23, so that the spray can 9 can be pushed instantly.

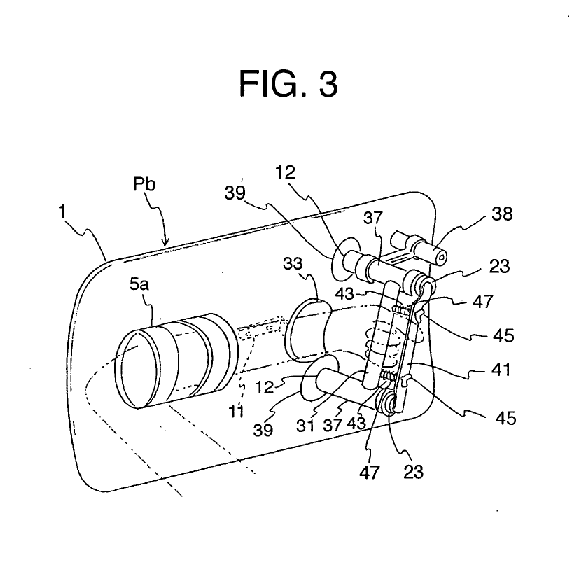

FIG. 3 shows a shield for self-defense provided with a spray device according to the second aspect of the invention, wherein a shield body 1 is formed in a curbed shape which is long sideways and projected toward the front face at the elevational center thereof. There are provided an extension handle 31 on the back face of the shield body 1 at the right side, a wrist pad 33 below the extension handle 31 and an arm holder 5a provided with a band at the left side.

Described hereinafter is the attachment of the extension handle 31. A pair of upper and lower support members 37, 37 between which the extension handle 31 is extended in are protruded from the shield body shield body 1, and they constitute a spray device 12 in which a spray can 9 is filled, and a spray handle is constituted between the support members 37, 37. Seat members 39, 39 made of softer plastic are provided under the support members 37, 37.

The spray handle is formed of a movable lever 41 which is attached to the extension handle 31 so as to be movable up and down, and which pushes the caps 23, 23 of the support members 37, 37 at the same time, wherein a pair of support bolts 43, 43 are protruded from the extension handle 31 while penetrating the movable lever 41, subsequently the upper end of the support bolts 43, 43 are threaded by nuts 45, 45 each serving as a stopper, and compression springs 47, 47 are inserted around the support bolts 43, 43 between the extension handle 31 and the movable lever 41.

With the arrangement of the shield for self-defense provided with a spray device of the second embodiment, if an operator counters mobs and so forth while placing his or her thumb on the movable lever 41 in a state where the extension handle 31 is gripped from below while holding his or her arm 7 passed through the arm holder 5a on the wrist pad 33, the operator immediately lowers the movable lever 41 in the case of emergency to push both caps 23, 23, thereby enabling the spray device 12 of the support member 37 to be actuated. Meanwhile, in this case, a hook piece 11 is attached to the back side of the shield body 1 while utilizing a screw, not shown, for attaching the wrist pad 33 to the shield body 1. A floodlight 38 is protruded from the shield body 1 from the back side thereof at the right side, wherein if a button provided at the tip end of the floodlight 38 is pushed, a flashing light for dazzling an opponent eyes is emitted through the transparent shield body 1.

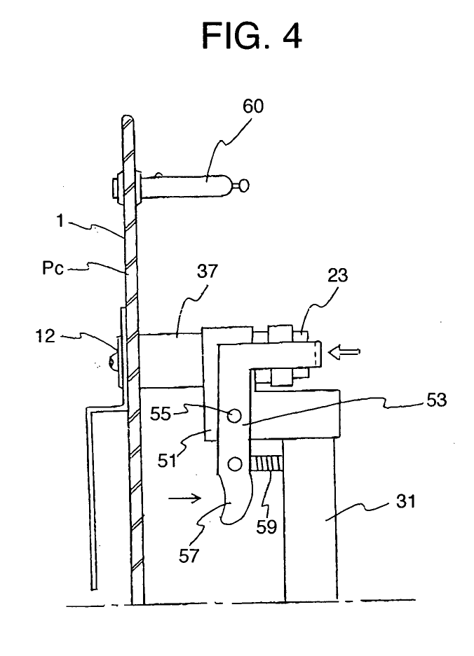

FIG. 4 shows a shield for self-defense provided with a spray device according to the third aspect of the invention. A shield for self-defense Pc provided with a spray device comprises upper and lower support members 37, 37 between which an extension handle 31 is connected, and a spray device 12 and a biforked trigger 53 are provided on the upper support member 37.

The trigger 53 is formed while clamping a connection member 51 for connecting the extension handle 31 and the support member 37, and extending over a cap 23 of the support member 37 at its tip end. The trigger 53 is connected to the connection member 51 by a pin 55 serving,as a pivoting axis and a compression spring 59 is intervened between a finger holding portion 57 for triggering the trigger 53 and the extension handle 31.

If the operator triggers the trigger 53 against the elasticity of the compression spring 59 while holding his or her finger for gripping the extension handle 31 on the finger holding portion 57, the tip end of the finger holding portion 57 is pushed downward pivotally around the pin 55, thereby pushing the cap 23 to push the spray can 9 inside the support member 37 so that the content inside the support member 37 is ejected toward the front face of the shield body 1. According to this embodiment, a floodlight 60 is provided at the upper end portion of the shield body 1 so as to instantaneously emit light for dazzling an opponent eyes.

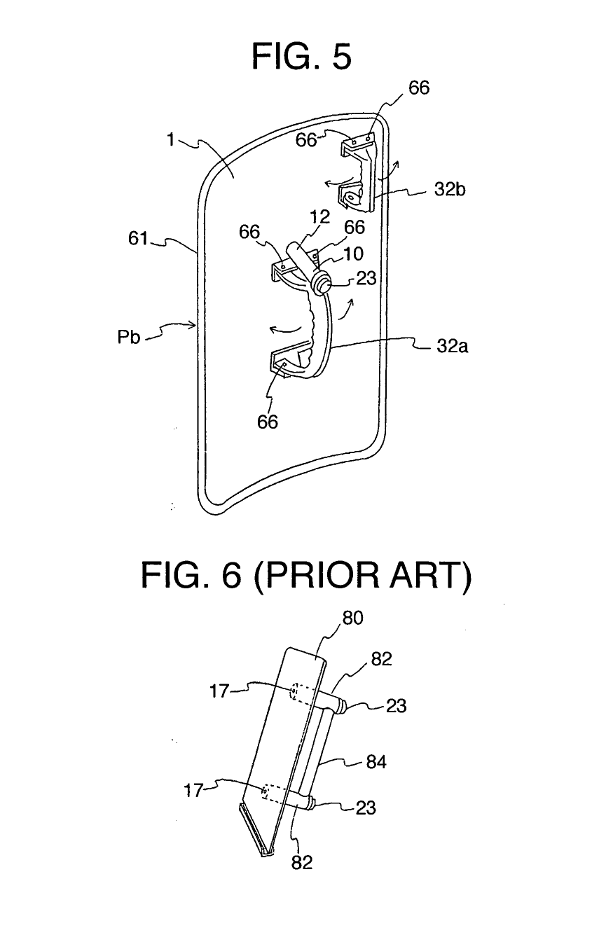

FIG. 5 shows a shield for self-defense provided with a spray device according to the fourth aspect of the invention. A shield for self-defense Pd provided with a spray device forms a shield body 1 having a curved shape wherein it is long longitudinally and projected toward the front face of the shield body 1 at the widthwise center thereof, and also has a bordering 61 made of rubber at the periphery thereof. The shield body 1 has a main handle 32a at the central portion and an auxiliary handle 32b at the upper right corner, and also a housing cylinder 10 of a spray can 9 at a portion adjacent to an upper portion of the main handle 32a for forming a spray device 12. With the arrangement of the shield for self-defense Pd provided with a spray device according to this embodiment, the operator can oppose an opponent while gripping the main and auxiliary handles by his or her both hands, and also ejects the content inside the spray can 9 by pushing a cap 23 of the spray device 12 by a thumb of a hand for gripping the main handle 32a.

Meanwhile, the shield for self-defense Pd provided with a spray device of this embodiment has an advantage that it can be easily kept while folded because the main and auxiliary handles 32a, 32b are foldable laterally and they can be laid down at both sides about the pins 66, 66 serving as axes (see arrows in FIG. 5).

As described in the foregoing, although the cap 23 serves for sealing the spray can 9, it also serves as a push button of the spray can 9. Accordingly, even if the cap 23 has a function to let the nozzle 21 of the spray can 9 to ejects the content in the spray can 9 (button function) while it has no function to seal the spray can 9 (cap function), it may be sufficient to have only button function without having the cap function.

What is claimed is:

1. A shield for self-defense provided with a spray device comprising:
a shield body;
a longitudinal handle serving as a spray device standing upright from a back face of the shield body so as to be gripped while laying an elbow on the back face of the shield body;
an arm holder for fixing the elbow thereon;
wherein the longitudinal handle and the arm holder are protruded from and disposed at the left and right sides on the central portion between the upper and lower portions of the shield body; and
wherein the longitudinal handle is shaped in a cylindrical form so as to house a spray can therein, and the spray can is covered with a cap provided at the upper end of the cylindrical form, and when the spray can is pushed by the cap, a spray for threat and defense can be ejected toward a front face of the shield body.

2. A shield for self-defense provided with a spray device comprising:
a shield body;
an extension handle serving as a spray device laid over and positioned away from the back face of the shield body so as to be gripped while laying an elbow on the back face of the shield body;
an arm holder for fixing the elbow thereon;
a wrist pad for laying a wrist thereon;
a pair of supporting members each shaped in a cylindrical form so as to house a spray can therein for supporting the extension handle extended therebetween; and
a movable lever provided over the extension handle to be gripped by a thumb to push the cap;
wherein the arm holder, the extension handle, and the wrist pad are disposed at the left and right sides of the shield body; and
wherein the spray can is covered with a cap provided at the upper end of the cylindrical form, and when the spray can is pushed by the cap, a spray for threat and defense can be ejected toward a front face of the shield body.

3. A shield for self-defense provided with a spray device comprising:
a shield body;
a pair of upper and lower supporting members each serving as a spray device and protruded from the back face of the shield body;
an extension handle extended between the supporting members;
a trigger connected to a connection member for connecting the extension handle and the upper supporting member by a pin;
wherein the supporting members are shaped in a cylindrical form so as to house a spray can therein, and the spray can is covered with a cap provided at the upper end of the cylindrical form, the cap being pushed by a tip end of the trigger, and when the spray can is pushed by the cap, a spray for threat and defense can be ejected toward a front face of the shield body.

4. A shield for self-defense provided with a spray device comprising:
a shield body;
a main handle (gripped vertically by a hand) protruded from the back face of the shield body at a central portion thereof; and
an auxiliary handle protruded from the back face of the shield body at either a right corner or a left corner of the upper portion thereof;
wherein both the main handle and the auxiliary handle or either the main handle or the auxiliary handle serves as a spray device, and the spray device has a housing cylinder in which a spray can is filled, and the housing cylinder is covered with a cap provided at the upper end thereof, and when the cap is pushed by a thumb, a spray for threat and defense can be ejected toward a front face of the shield body.
